(19) United States
(12) Patent Application Publication
(10) Pub. No.: US 2024/0282057 A1
(43) Pub. Date: Aug. 22, 2024

(54) AUGMENTATION OF VOLUMETRIC VIDEO WITH NON-VISUAL INFORMATION IN A VIRTUAL REALITY ENVIRONMENT

(71) Applicant: INTERNATIONAL BUSINESS MACHINES CORPORATION, Armonk, NY (US)

(72) Inventors: Sarbajit K. RAKSHIT, Kolkata (IN); Vinod A. VALECHA, Pune (IN)

(21) Appl. No.: 18/172,054

(22) Filed: Feb. 21, 2023

(51) Int. Cl. G06T 19/00; G06F 3/16; G06T 7/70; H04N 23/23

(52) U.S. Cl. CPC G06T 19/006; G06F 3/16; G06T 7/70; G06T 19/003; H04N 23/23; G06T 2207/10044

(57) ABSTRACT

A computational device of a virtual reality system receives a volumetric video that captures visual information of a physical environment. The computational device of the virtual reality system receives non-visual information of the physical environment. The volumetric video is integrated with the non-visual information to generate a volumetric video augmented with non-visual information in which navigation is performed in the virtual reality system.

### BACKGROUND

### 1. Field

Embodiments relate to a method, system, and computer program product for the augmentation of volumetric video with non-visual information in a virtual reality environment.

### 2. Background

Virtual Reality may be described as a computer-generated environment with scenes and objects that appear to be real, making users feel as if they are immersed in their surroundings. The computer-generated environment is perceived through a device known as a virtual reality device that may include a virtual reality headset, a virtual reality helmet, a virtual reality handheld device, etc.

A virtual reality device may perform many types of activities. A virtual reality device may be used for playing games, for multi-user collaboration, for remote activities, for software development, etc. The user does not have to move to a physical site for performing the activities in a virtual reality environment. By using the virtual reality device, a user may be able to secure the entire working environment in the current physical surrounding of the user. As a result, a user may perform various activities from a remote location, and the user may secure the working environment in the virtual reality device.

A volumetric video records video in three dimensions, capturing an object or space three-dimensionally. The volumetrically captured object and environment may be transferred to virtual reality environments to be viewed in three dimensions. Within the volumetric video, users can view the media from various directions, and they can also use virtual reality systems or three-dimensional display systems or a two-dimensional display system to interact with the volumetric video.

### SUMMARY OF THE PREFERRED EMBODIMENTS

Provided are a method, system, and computer program product in which a computational device of a virtual reality system receives a volumetric video that captures visual information of a physical environment, The computational device of the virtual reality system receives non-visual information of the physical environment. The volumetric video is integrated with the non-visual information to generate a volumetric video augmented with non-visual information in which navigation is performed in the virtual reality system. As a result, a volumetric video is improved to include non-visual information and a virtual reality environment is enhanced for a user.

In certain embodiments, the non-visual information includes a thermal imagery of the physical environment, where the thermal imagery is captured by an infrared camera. As a result, a user may be able to perceive temperature in a virtual reality environment.

In further embodiments, the non-visual information includes an airflow information within the physical environment, where the airflow information is additionally captured by an airflow measurement device. As a result, a user may be able to perceive the flow of air in a virtual reality environment. In yet further embodiments, the non-visual information includes a radar imagery,

where the radar imagery is captured additionally by a radar that determines location and orientation of objects in the physical environment. As a result, a user may be able to perceive the three-dimensional environment including distances and orientation of objects in a virtual reality environment.

In certain embodiments, the non-visual information includes a sound level at different locations in the physical environment, where the sound level is captured additionally by a sound level measurement device that determines the sound level at the different locations in the physical environment. As a result, a user may be able to perceive the sound levels at various locations in a virtual reality environment.

In additional embodiments, a user is able to perceive the physical environment including at least a temperature and an airflow information in addition to the visual information within the physical environment in the virtual reality system, and the user is able to navigate within the volumetric video augmented with non-visual information in the virtual reality system. As a result, a user may be able to navigate in a virtual reality environment while sensing temperature and airflow information.

In yet additional embodiments, a learning mechanism improves a selection of the non-visual information to integrate with the volumetric video to generate the volumetric video augmented with non-visual information. As a result, the perception of non-visual information may improve over time for a user.

### BRIEF DESCRIPTION OF THE DRAWINGS

Referring now to the drawings in which like reference numbers represent corresponding parts throughout:

FIG. 1 illustrates a block diagram of a computing environment for a virtual reality device, in accordance with certain embodiments.

FIG. 2 illustrates a block diagram that shows certain types of devices for generating volumetric video augmented with non-visual information, in accordance with certain embodiments.

FIG. 3 illustrates a block diagram that shows the generation and usage of volumetric video augmented with non-visual information, in accordance with certain embodiments.

FIG. 4 illustrates a block diagram that shows the generation and usage of volumetric video augmented with non-visual information, in accordance with certain additional embodiments.

FIG. 5 illustrates a block diagram that shows additional features for the generation and usage of volumetric video augmented with non-visual information, in accordance with certain additional embodiments.

FIG. 6 illustrates a block diagram that shows characteristics of non-visual information that is captured, in accordance with certain additional embodiments.

FIG. 7 illustrates a flowchart that shows operations for the generation and usage of volumetric video augmented with non-visual information, in accordance with certain additional embodiments.

FIG. 8 illustrates a computing environment in which certain components of FIG. 1 may be implemented, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

Volumetric video technology may use cameras and advanced data processing to render three-dimensional (3D) images from a virtual space, which allows for video point of views to be generated from any angle within that space to create a more immersive experience for viewers. Within the volumetric video, a user may view the media from various directions, while using a virtual reality system or a 3D display system or any two-dimensional (2D) display system.

Volumetric videos may allow the use of new mechanisms for collaboration and enable virtual offices to be created. Volumetric videos involve processing feeds from multiple cameras from various directions to create a volume of video. For creating a volumetric video, computing devices process and combine multiple image feeds that have been captured from different directions. Volumetric videos may be watched with virtual reality devices, and based on navigation in the virtual reality environment, the user may access the elements in the volumetric videos.

Captured volumetric video may potentially be shared with any communication channel including social networks. The quality of volumetric video may depend on how many directional videos are considered, their respective quality of video, etc.

The purpose of a volumetric video is to provide an immersive experience to the user. A user can view the volumetric video from any suitable direction. However, for many users, perceiving visual content alone is not sufficient, and various sensory parameters that include non-visual information are also important. Such sensory parameters of importance may include information on temperatures, wind flow rates, level of sounds, etc., in different portions of the volumetric video.

In certain embodiments, audio information can be integrated into volumetric videos. For example, based on relative movement (e.g., the speed of the user with respect to the source of sound inside the volumetric video) the Doppler effect may be perceived by a user within a volumetric video. This may enhance the viewing experience of the volumetric video. Certain embodiments augment the volumetric video with a plurality of different non-visual information to enhance the perception of the volumetric video for a user.

Aspects of the present disclosure provide various improvements to the processing of volumetric videos in a virtual reality environment by augmenting volumetric videos with non-visual information. As a result, aspects of the present disclosure improve the operations of computational devices that support volumetric video in a virtual reality environment. The integration of non-visual information in volumetric videos improves the operations of a computational device by providing non-visual information to a user in association with the volumetric video. Additionally learning mechanisms can be used to improve the augmentation of volumetric videos with non-visual information, and as a result, the operations of a computational device can be improved.

### Exemplary Embodiments

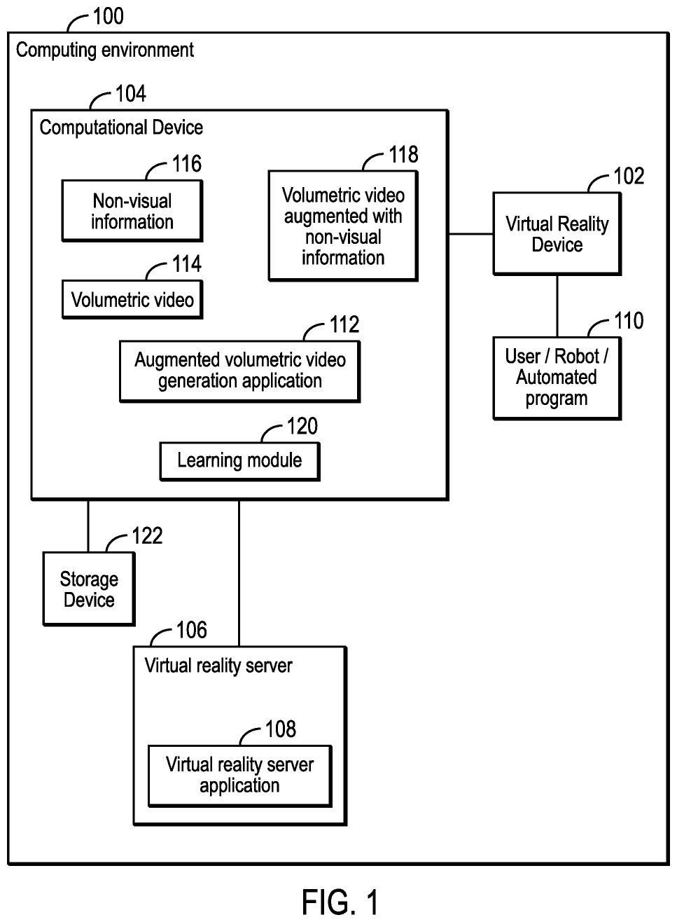

FIG. 1 illustrates a block diagram of a computing environment 100 for a virtual reality device 102, in accordance with certain embodiments. The virtual reality device 102 may be communicatively coupled to a computational device 104. In certain alternative embodiments, the virtual reality device 102 may include the computational device 104 or may be included within the computational device 104.

The virtual reality device 102 may be communicatively coupled to a virtual reality server 106 via the computational device 104. A virtual reality server application 108 may execute in the virtual reality server 106. An entity 110, such as a virtual reality user, a robot, or a program may interact with the virtual reality device 102.

In certain embodiments, the virtual reality device 102, the computational device 104, and the virtual reality server 106 may comprise any suitable computational device including those presently known in the art, such as, a personal computer, a workstation, a server, a mainframe, a hand held computer, a palm top computer, a head mounted computer, a telephony device, a network appliance, a blade computer, a processing device, a controller, etc.

The virtual reality device 102, the computational device 104, and the virtual reality server 106 may be elements in any suitable network, such as, a storage area network, a wide area network, the Internet, an intranet, etc. In certain embodiments, the virtual reality device 102, the computational device 104, and the virtual reality server 106 may be elements in a cloud computing environment.

The computational device 104 includes an augmented volumetric video generation application 112 that may integrate non-visual information 116 into a volumetric video 114 to generate a volumetric video augmented with non-visual information 118. The volumetric video augmented with non-visual information 118 may also be referred to as non-visual information augmented volumetric video or augmented volumetric video. A learning module 120 may be used to support the operations of the augmented volumetric video generation application 112. In certain embodiments, the augmented volumetric video generation application 112 and the learning module 120 may be implemented in software, hardware, firmware, or any combination thereof.

A storage device 122 that stores data for the computational device 104 may be communicatively coupled to the computational device 104. The volumetric video 114, the non-visual information 116, and the volumetric video augmented with non-visual information 118 may be stored in the storage device 122.

Therefore, FIG. 1 illustrates a computing environment 100 in which an augmented volumetric video generation application 112 augments a volumetric video 114 with non-visual information 116 to generate a volumetric video augmented with non-visual information 118, in a virtual reality computing environment.

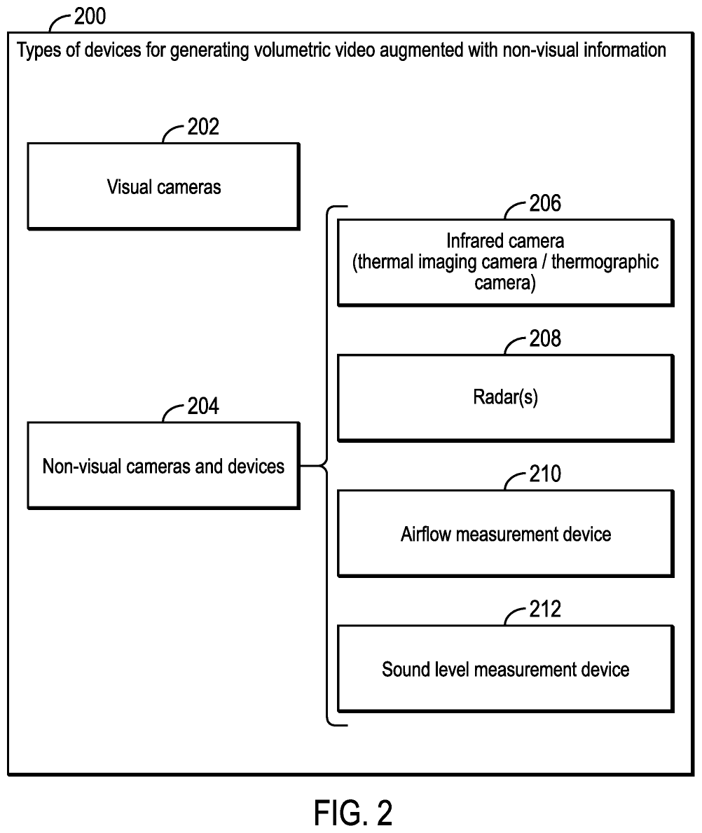

FIG. 2 illustrates a block diagram 200 that show certain types of devices for generating the volumetric video augmented with non-visual information 118, in accordance with certain embodiments.

Visual cameras 202 may be used to generate volumetric video. Non-visual cameras and devices 204 may be used to generate the non-visual information that may augment the volumetric video captured via the visual cameras 202.

A few non-visual cameras and devices are shown in FIG. 2. Such non-visual cameras and devices may include one or more infrared cameras 206 (alternatively known as thermal imaging camera or thermographic camera), one or more radars 208, one or more airflow measurement devices 210, and one or more sound measurement devices 212, among other potential non-visual devices.

In additional embodiments, additional devices that capture additional non-visual information may be included to improve the perception of volumetric video for a user. For example, laser imaging, detection and ranging (Lidar) devices may use laser scanning for measuring and recording landscapes in order to create three-dimensional scan and depth maps. Lidars may produce three-dimensional point clouds, which account for every point in a space where such points are represented as voxels that include depth information. While the radars 208 shown in FIG. 2 may use radio waves for determining depth, lidars may use lasers to determine depth. For determining depths in underwater environments, sound navigation and ranging (sonar) devices may be used instead of the radars 208.

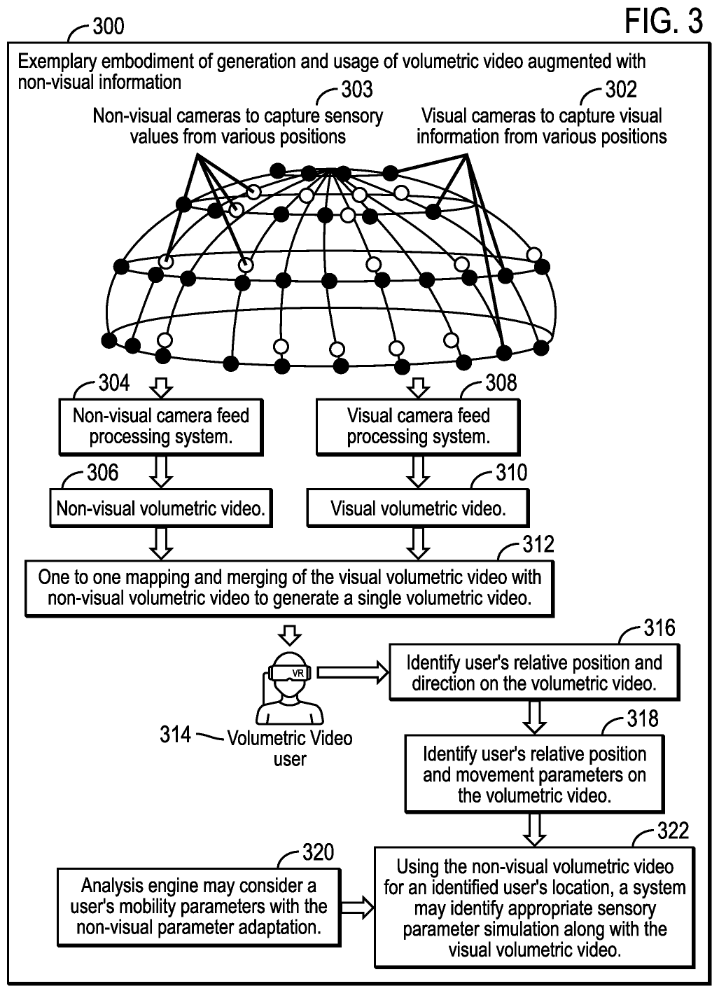

FIG. 3 illustrates a block diagram 300 that shows the generation and usage of volumetric video augmented with non-visual information, in accordance with certain embodiments.

FIG. 3 shows a set of visual cameras 302 in a physical surrounding, where the visual cameras operate from various positions to capture visual information. A set of non-visual cameras 303 that are used in a physical surrounding to capture sensory values from various positions are also shown.

In FIG. 3, blocks 304 and 306 show non-visual camera feeds being used to generate a non-visual volumetric video. For example, a software module such as a non-visual camera feed processing system 304 may process non-visual camera feeds obtained from the non-visual cameras 303 to generate the non-visual volumetric video 306. Blocks 308 and 310 show a visual camera feed being used to generate a visual volumetric video. For example, a software module such as a visual camera feed processing system 308 may process visual camera feeds obtained from the visual cameras 302 to generate the visual volumetric video 310. From blocks 306 and 310, control proceeds to block 312 in which a one-to-one mapping and merging of the visual volumetric video 310 with the non-visual volumetric video 306 is performed to generate a single volumetric video referred to as volumetric video augmented with non-visual information.

FIG. 3 also shows a volumetric video user 314 who interacts in a virtual reality environment with the single volumetric video (i.e., the volumetric video augmented with non-visual information). An exemplary system may identify a user's relative position and direction on the volumetric video (reference numeral 316), and may also identify a user's relative position and movement parameters on the volumetric video augmented with non-visual information (reference numeral 318). Within the non-visual volumetric video for an identified user's location, an exemplary system may identify appropriate sensory parameter simulation along with the visual volumetric video (reference numeral 322). An analysis engine may consider a user's mobility parameters with the non-visual parameter adaptation (reference numeral 320).

Therefore, FIG. 3 shows a volumetric video capturing system that uses non-visual cameras along with visual cameras, and that creates two volumetric videos, where one is with visual camera feeds, and another is with non-visual cameras. The embodiments may create and store a one-to-one mapping between visual and non-visual spatial locations, and accordingly the non-visual volumetric video content may be regenerated based on a user's relative position and mobility parameters on the visual volumetric parameters. For example, a three-dimensional location (x, y, z) has the red, green, and blue pixel values determined by a visual camera feed and the temperature level in Celsius determined by a feed of a non-visual camera comprising a thermal camera. In this example, when a user is navigating within the visual volumetric video at location (x, y, z), the corresponding temperature level at location (x, y, z) may be generated for the user, based on the one-to-one mapping between the visual and non-visual spatial locations.

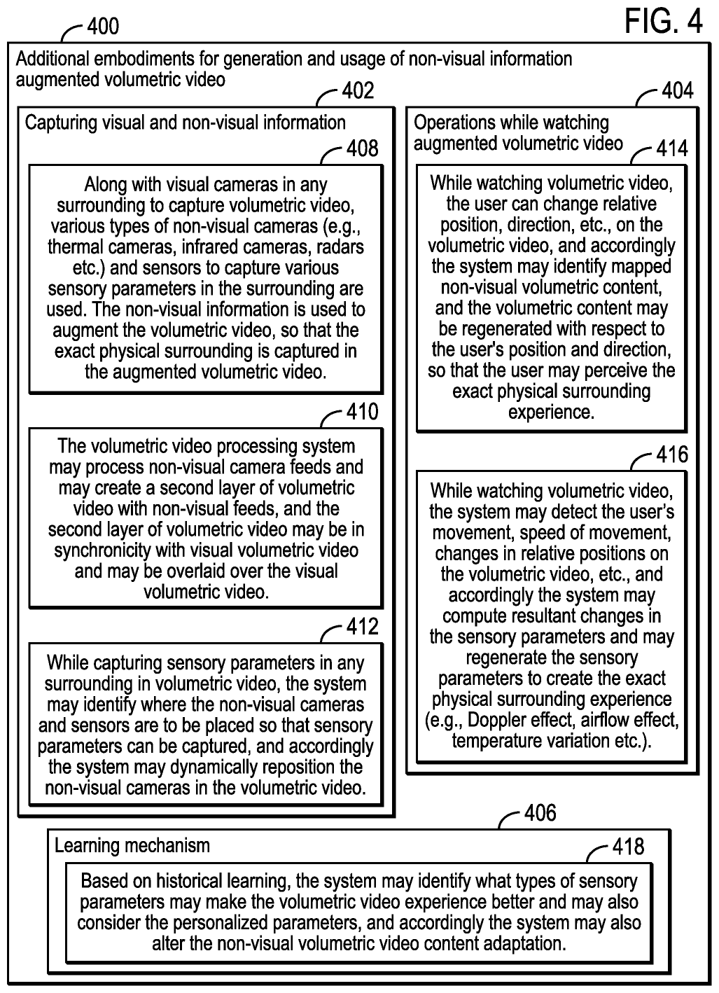

FIG. 4 illustrates a block diagram 400 that shows the generation and usage of volumetric video augmented with non-visual information, in accordance with certain additional embodiments. FIG. 4 also shows the capturing of visual and non-visual information 402 operations while a user is watching augmented volumetric video (reference numeral 404), and the application of learning mechanisms 406.

In certain embodiments along with visual cameras in any surrounding to capture volumetric video, various types of non-visual cameras (e.g., thermal cameras, infrared cameras, radars, etc.) and sensors to capture various sensory parameters in a physical surrounding are also used. Such embodiments may make the non-visual information a part of the volumetric video (e.g., the captured sensory parameters may be temperature, presence of humidity in the surrounding, wind flow parameters, etc.), so that the details of the physical surrounding may be captured in the volumetric video (shown via reference numeral 408)

The volumetric video processing system may process non-visual camera feeds and may create a second layer of volumetric video with non-visual feeds. The second layer may be in synchronicity with visual camera volumetric video and may be overlaid over the visual volumetric video (shown via reference numeral 410).

While watching the volumetric video, the user may change their relative position, direction, etc., on the volumetric video, and accordingly the system may identify mapped non-visual volumetric content. The non-visual volumetric content may be regenerated with respect to the user's position and direction, so that the user may feel the physical surrounding experience (shown via reference numeral 414).

While watching volumetric video, the system may detect the user's movement, speed of movement, changes in relative positions on the volumetric video, etc., and accordingly the system may compute resultant changes in the sensory parameters and may regenerate the sensory parameters to create a physical surrounding experience (e.g., Doppler effect, airflow effect, temperature variation, etc.) [as shown via reference numeral 416].

While capturing sensory parameters in any surrounding in a volumetric video, the system may be identifying where the non-visual cameras and sensors are to be placed so that sensory parameters can be captured effectively, and accordingly the system may dynamically reposition the non-visual cameras in the volumetric video capturing the physical surrounding (as shown via reference numeral 412).

Based on historical learning, the system may identify what types of sensory parameters may make the volumetric video experience better and the system may also consider the integration of personalized parameters. The system may also alter the non-visual volumetric video content adaptation (as shown via reference numeral 418). For example, in one embodiment a neural network based learning system may determine that the experience is improved when temperature is incorporated with visual information, whereas the incorporation of sound does little to improve the experience. In such embodiments, the system may incorporate temperature but exclude sound from the volumetric video. However, a particular user may want to experience sound and may indicate that in their personalized parameters. For this user, sound may be considered for incorporation into the volumetric video. Content adaptation may refer to mechanisms by which the non-visual information is adapted for incorporation to the volumetric video. For example, sound levels that are higher than a threshold decibel may be incorporated into the volumetric video, and sound levels that are equal to or lower than the threshold decibel level may not be incorporated.

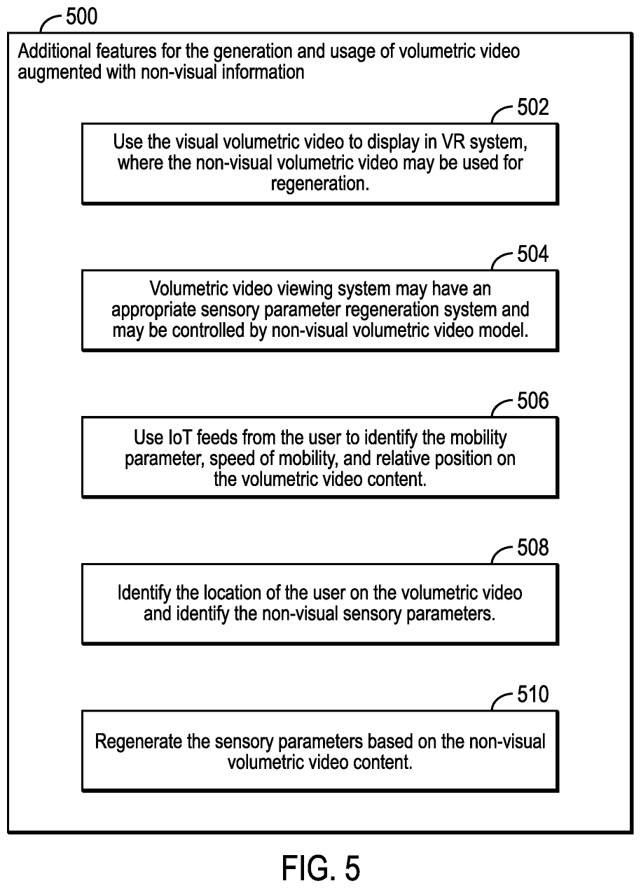

FIG. 5 illustrates a block diagram 500 that shows additional features for the generation and usage of volumetric video augmented with non-visual information, in accordance with certain additional embodiments.

In certain embodiments the system may use the visual volumetric video for display in a virtual reality system, and the non-visual volumetric video may be used for regeneration (reference numeral 502).

The volumetric video viewing system may have an appropriate sensory parameter regeneration system and may be controlled by a non-visual volumetric video model (reference numeral 504).

The system may also be using Internet of Things (IoT) feeds from the user to identify the mobility parameter, speed of mobility, and relative position on the volumetric video content (reference numeral 506)

The system may also identify the location of the user on the volumetric video and may also identify the non-visual sensory parameters (reference numeral 508).

The system may also be regenerating the sensory parameters based on the non-visual volumetric video content (reference numeral 510).

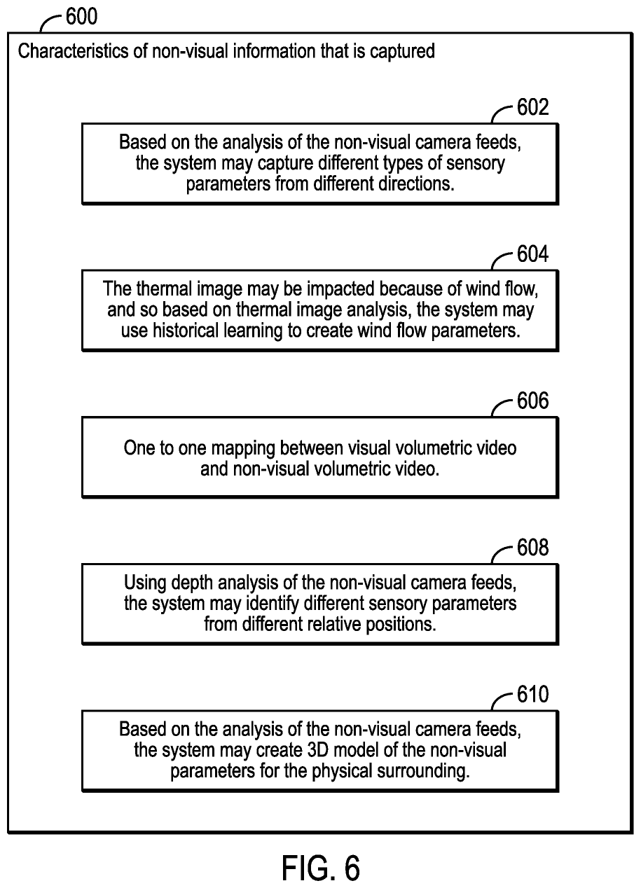

FIG. 6 illustrates a block diagram 600 that shows characteristics of non-visual information that is captured, in accordance with certain additional embodiments.

Based on the analysis of the non-visual camera feeds, the system may be capturing different types of sensory parameters from different directions (reference numeral 602).

The thermal image may be impacted because of wind flow, and so, based on thermal image analysis and information acquired by airflow measurement devices 210, the system may use historical learning to create wind flow parameters (reference numeral 604). For example, if the temperature of south facing slopes of a mountain range is determined to be colder than the north facing slopes, then a determination may be made that colder wind may have been blowing towards the south facing slopes in the volumetric video that has been augmented with temperatures. The temperature and velocity of the wind may be computed and may be referred to as the creation of wind flow parameters.

The system may create a one-to-one mapping between the visual volumetric video and the non-visual volumetric video (reference numeral 606) at each three-dimensional location. For example, a color may be associated with a three-dimensional spatial location (x, y, z) in a visual volumetric video, whereas a depth (i.e., a distance) may be associated with the corresponding three-dimensional spatial location in the non-visual volumetric video captured by a radar. In this example, when a user is navigating within the visual volumetric video at location (x, y, z), the corresponding depth at location (x, y, z) may be generated for the user, based on the one-to-one mapping between the visual and non-visual spatial locations.

Using depth analysis of the non-visual camera feeds, the system may identify different sensory parameters from different relative positions (reference numeral 608).

Depth analysis may be performed based on distances of objects in a physical environment computed via a radar. The depth analysis may include qualitative or quantitative interpretation related to the distances of objects that is performed in a volumetric video augmented with distances of objects. Thus sensory parameters such as distances of objects may be perceived by a user in a volumetric video. Based on the analysis of the non-visual camera feeds, the system may create a three-dimensional model of the non-visual parameters for the physical surrounding (reference numeral 610).

The non-visual image processing system may be classifying the non-visual camera feeds and may be mapping the same with sensory parameters. In certain embodiments, a non-visual volumetric video processing engine creates a non-visual volumetric video of the surrounding. The system may identify the relative positions of visual cameras and non-visual cameras and accordingly may identify a relative position of the physical object and sensory parameters. In certain embodiments, the system may create two volumetric videos of the surrounding, where one is a visual camera volumetric video and the other is a non-visual camera volumetric video.

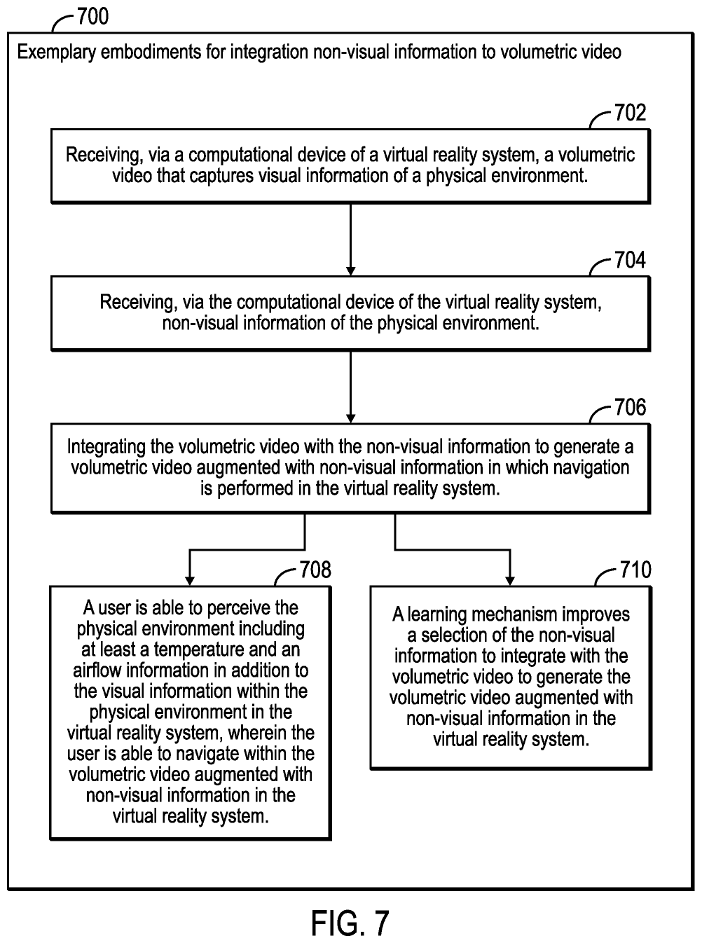

FIG. 7 illustrates a flowchart 700 that shows operations for the generation and usage of volumetric video augmented with non-visual information, in accordance with certain additional embodiments.

Control starts at block 702 in which a computational device 104 of a virtual reality system receives a volumetric video that captures visual information of a physical environment. The computational device 104 of the virtual reality system receives non-visual information of the physical environment (at block 704). The volumetric video is integrated with the non-visual information to generate (at block 706) a volumetric video augmented with non-visual information in which navigation is performed in the virtual reality system.

In certain embodiments, the non-visual information includes a thermal imagery of the physical environment, wherein the thermal imagery is captured by an infrared camera. In further embodiments, the non-visual information includes an airflow information within the physical environment, wherein the airflow information is additionally captured by an airflow measurement device. In yet further embodiments, the non-visual information includes a radar imagery, wherein the radar imagery is captured additionally by a radar that determines location and orientation of objects in the physical environment. In certain embodiments, the non-visual information includes a sound level at different locations in the physical environment, wherein the sound level is captured additionally by a sound level measurement device that determines the sound level at the different locations in the physical environment.

From block 706 control proceeds to block 708 and block 710. At block 708, a user is able to perceive the physical environment including at least a temperature and an airflow information in addition to the visual information within the physical environment in the virtual reality system, wherein the user is able to navigate within the volumetric video augmented with non-visual information in the virtual reality system. At block 710, a learning mechanism improves a selection of the non-visual information to integrate with the volumetric video to generate the volumetric video augmented with non-visual information. For example, a neural network based learning mechanism may determine that users generally use temperature information and not sound information in conjunction with volumetric video. As a result, the learning mechanism may choose not to augment the volumetric video with sound information.

Therefore, FIGS. 1-7 illustrate certain embodiments for integrating non-visual information with volumetric video to generate a volumetric video augmented with non-visual information and then navigate within the volumetric video augmented with non-visual information in a virtual reality environment. For example, the Doppler effect may be incorporated when sound is used to augment a volumetric video and objects in the physical environment are moving. The Doppler effect is the apparent change in frequency of a wave in relation to an observer who is moving relative to the wave source. For example, in a volumetric video augmented with sound information, a change of pitch may be heard when a vehicle sounding a horn approaches or recedes from a user who is navigating in the volumetric video augmented with the sound information. Various aspects of the present disclosure are described by narrative text,

flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

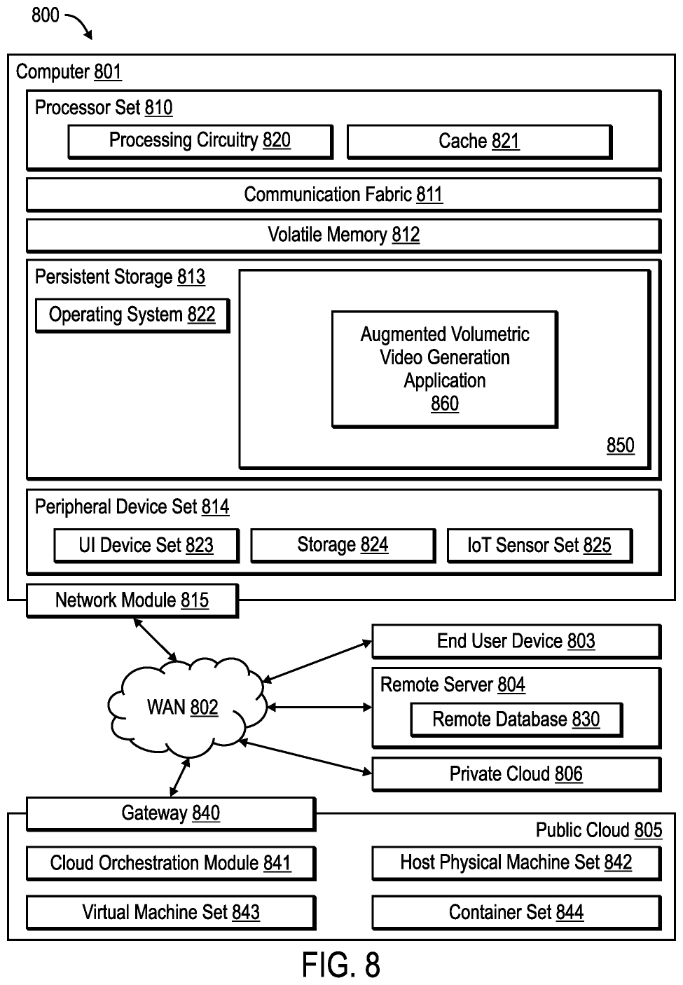

In FIG. 8, computing environment 800 contains an example of an environment for the execution of at least some of the computer code (block 850) involved in performing the operations of the augmented volumetric video generation application 860.

In addition to block 850, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 850, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type

now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 850 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid-state storage devices. Operating system 822 may take several forms, such as various known proprietary operating systems or open-source Portable Operating System Interface-type operating systems that employ a kernel. The code included in block 850 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking

(SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

Several examples will now be provided to further clarify various aspects of the present disclosure:

Example 1: A method comprising receiving, via a computational device of a virtual reality system, a volumetric video that captures visual information of a physical environment. The method also includes receiving, via the computational device of the virtual reality system, non-visual information of the physical environment, and integrating the volumetric video with the non-visual information to generate a volumetric video augmented with non-visual information in which navigation is performed in the virtual reality system.

Example 2: The limitations of Example 1, wherein the non-visual information includes a thermal imagery of the physical environment, wherein the thermal imagery is captured by an infrared camera.

Example 3: The limitations of any of Examples 1-2, wherein the non-visual information includes an airflow information within the physical environment, wherein the airflow information is additionally captured by an airflow measurement device.

Example 4: The limitations of any of Examples 1-3, wherein the non-visual information includes a radar imagery, and wherein the radar imagery is captured additionally by a radar that determines location and orientation of objects in the physical environment.

Example 5: The limitations of any of Examples 1-4, wherein the non-visual information includes a sound level at different locations in the physical environment, and wherein the sound level is captured additionally by a sound level measurement device that determines the sound level at the different locations in the physical environment.

Example 6: The limitations of any of Examples 1-5, wherein a user is able to perceive the physical environment including at least a temperature and an airflow information in addition to the visual information within the physical environment in the virtual reality system, and wherein the user is able to navigate within the volumetric video augmented with non-visual information in the virtual reality system.

Example 7: The limitations of any of Examples 1-6, wherein a learning mechanism improves a selection of the non-visual information to integrate with the volumetric video to generate the volumetric video augmented with non-visual information.

Example 8: A system comprising a memory and a processor coupled to the

memory, wherein the processor performs a method according to any of Examples 1-7.

Example 9: A computer program product comprising a computer readable storage medium having computer readable program code embodied therewith, wherein the computer readable program code when executed is configured to perform a method according to any of Examples 1-7.

What is claimed is:

1. A method comprising:
receiving, via a computational device of a virtual reality system, a volumetric video that captures visual information of a physical environment;
receiving, via the computational device of the virtual reality system, non-visual information of the physical environment; and
integrating the volumetric video with the non-visual information to generate a volumetric video augmented with non-visual information in which navigation is performed in the virtual reality system.

2. The method of claim 1, wherein the non-visual information includes a thermal imagery of the physical environment, and wherein the thermal imagery is captured by an infrared camera.

3. The method of claim 2, wherein the non-visual information includes an airflow information within the physical environment, and wherein the airflow information is additionally captured by an airflow measurement device.

4. The method of claim 3, wherein the non-visual information includes a radar imagery, and wherein the radar imagery is captured by a radar that determines location and orientation of objects in the physical environment.

5. The method of claim 4, wherein the non-visual information includes a sound level at different locations in the physical environment, and wherein the sound level is captured additionally by a sound level measurement device that determines the sound level at the different locations in the physical environment.

6. The method of claim 1, wherein a user is able to perceive the physical environment including at least a temperature and an airflow information in addition to the visual information within the physical environment in the virtual reality system, and wherein the user is able to navigate within the volumetric video augmented with non-visual information in the virtual reality system.

7. The method of claim 1, wherein a learning mechanism improves a selection of the non-visual information to integrate with the volumetric video to generate the volumetric video augmented with non-visual information.

8. A system, comprising:
a memory; and
a processor coupled to the memory, wherein the processor performs operations, the operations comprising:
receiving, in a virtual reality system, a volumetric video that captures visual information of a physical environment;
receiving, in the virtual reality system, non-visual information of the physical environment; and
integrating the volumetric video with the non-visual information to generate a volumetric video augmented with non-visual information in which navigation is performed in the virtual reality system.

9. The system of claim 8, wherein the non-visual information includes a thermal imagery of the physical environment, and wherein the thermal imagery is captured by an infrared camera.

10. The system of claim 9, wherein the non-visual information includes an airflow information within the physical environment, and wherein the airflow information is additionally captured by an airflow measurement device.

11. The system of claim 10, wherein the non-visual information includes a radar imagery, and wherein the radar imagery is captured by a radar that determines location and orientation of objects in the physical environment.

12. The system of claim 11, wherein the non-visual information includes a sound level at different locations in the physical environment, and wherein the sound level is captured additionally by a sound level measurement device that determines the sound level at the different locations in the physical environment.

13. The system of claim 8, wherein a user is able to perceive the physical environment including at least a temperature and an airflow information in addition to the visual information within the physical environment in the virtual reality system, and wherein the user is able to navigate within the volumetric video augmented with non-visual information in the virtual reality system.

14. The system of claim 8, wherein a learning mechanism improves a selection of the non-visual information to integrate with the volumetric video to generate the volumetric video augmented with non-visual information.

15. A computer program product, the computer program product comprising a computer readable storage medium having computer readable program code embodied therewith, the computer readable program code when executed is configured to perform operations, the operations comprising:
receiving, via a computational device of a virtual reality system, a volumetric video that captures visual information of a physical environment;
receiving, via the computational device of the virtual reality system, non-visual information of the physical environment; and
integrating the volumetric video with the non-visual information to generate a volumetric video augmented with non-visual information in which navigation is performed in the virtual reality system.

16. The computer program product of claim 15, wherein the non-visual information includes a thermal imagery of the physical environment, and wherein the thermal imagery is captured by an infrared camera.

17. The computer program product of claim 16, wherein the non-visual information includes an airflow information within the physical environment, and wherein the airflow information is additionally captured by an airflow measurement device.

18. The computer program product of claim 17, wherein the non-visual information includes a radar imagery, and wherein the radar imagery is captured by a radar that determines location and orientation of objects in the physical environment.

19. The computer program product of claim 18, wherein the non-visual information includes a sound level at different locations in the physical environment, and wherein the sound level is captured additionally by a sound level measurement device that determines the sound level at the different locations in the physical environment.

20. The computer program product of claim 15, wherein a user is able to perceive the physical environment including at least a temperature and an airflow information in addition to the visual information within the physical environment in the virtual reality system, and wherein the user is able to navigate within the volumetric video augmented with non-visual information in the virtual reality system.
